(19) United States
(12) Patent Application Publication
(10) Pub. No.: US 2022/0227434 A1
(43) Pub. Date: Jul. 21, 2022

(54) VEHICLE LOAD ROOM STRUCTURE

(71) Applicant: HONDA MOTOR CO., LTD., Tokyo (JP)

(72) Inventor: Naoto Takeshita, Tokyo (JP)

(21) Appl. No.: 17/549,918

(22) Filed: Dec. 14, 2021

(30) Foreign Application Priority Data
Jan. 21, 2021 (JP) 2021-007837

(51) Int. Cl. B62D 43/06

(52) U.S. Cl. CPC B62D 43/06

(57) ABSTRACT

A load room includes an accommodation recess part that accommodates an article. A rear upper portion of the accommodation recess part is constituted of a rear panel block. At least two notch parts and a swing part that is sandwiched by two of the notch parts and is swingable in a vehicle front-to-rear direction are provided on a front wall that faces an inside of the accommodation recess part of the rear panel block.

### CROSS-REFERENCE TO RELATED APPLICATION

Priority is claimed on Japanese Patent Application No. 2021-007837, filed on Jan. 21, 2021, the contents of which are incorporated herein by reference.

### BACKGROUND

### Field of the Invention

The present invention relates to a vehicle load room structure that includes an accommodation recess part which accommodates an article such as a spare tire.

### Background

Vehicles are known in which an accommodation recess part is provided on a floor surface of a load room, and an article such as a spare tire can be accommodated in the accommodation recess part. In a load room of this type of vehicle, an upper portion of the accommodation recess part is closed by a detachable lid member.

As a spare tire that is installed on a vehicle, two types of spare tires are known, namely a standard tire having the same size as an ordinary travel tire and a temporary tire having a smaller outer diameter and a narrower width than the standard tire. In recent years, some vehicles have a load room structure that can accommodate both the standard tire and the temporary tire (for example, refer to Japanese Unexamined Patent Application, First Publication No. 2016-41554).

In the load room structure described in Japanese Unexamined Patent Application, First Publication No. 2016-41554, a notch part having an arc shape for allowing a standard tire having a large outer form to be accommodated is provided on a front part in a middle region in a vehicle width direction of a rear panel block that forms a rear upper portion of the accommodation recess part. The notch part of the rear panel block is closed by a detachable complementary component. When the temporary tire is accommodated within the accommodation recess part, the notch part is closed by the complementary component, and when the standard tire is accommodated within the accommodation recess part, the complementary component is detached.

### SUMMARY

In the load room structure described in Japanese Unexamined Patent Application, First Publication No. 2016-41554, it is necessary to detach or attach the complementary component when accommodating the standard tire in the accommodation recess part or when accommodating the temporary tire in the accommodation recess part. Therefore, a user is forced to perform cumbersome detachment and attachment work of the complementary component, and improvement in this area is desired.

Further, in the load room structure described in Japanese Unexamined Patent Application, First Publication No. 2016-41554, when the complementary component is detached from the rear panel block, it is necessary to store the detached complementary component, and management of the complementary component is inconvenient. Further, when the complementary component is detached from the rear panel block, since a large notch part is exposed at a front part of the rear panel block, the appearance from the outside is degraded, and improvement in this area is also desired.

An aspect of the present invention provides a vehicle load room structure that can easily change an accommodation form of an article without requiring cumbersome detachment and attachment of a component even when accommodating articles having a different size in an accommodation recess part.

A vehicle load room structure according to an aspect of the present invention includes: an accommodation recess part that is provided in a load room of a vehicle and accommodates an article, wherein a rear upper portion of the accommodation recess part is constituted of a rear panel block, and at least two notch parts and a swing part that is sandwiched by two of the notch parts and is swingable in a vehicle front-to-rear direction are provided on a front wall that faces an inside of the accommodation recess part of the rear panel block.

According to the configuration described above, when a small article is accommodated in the accommodation recess part, the article is accommodated in the accommodation recess part as is. When a large article is accommodated in the accommodation recess part, the swing part on the front wall of the rear panel block is swung, and the article is accommodated in the accommodation recess part. The swing part swings by being applied with an external force, thereby enlarges a volume of the accommodation recess part in which an article can be accommodated, and returns to an original state by a reaction force by the external force being released. Accordingly, it is possible to easily change an accommodation form of an article without requiring cumbersome detachment and attachment of a component.

The plurality of notch parts that are provided on the front wall may have an upper end height that is aligned to each other and have a lower end that opens downward, a section that connects together upper end portions of the notch parts of the front wall may be a shaft portion, and the swing part may be swingable around the shaft portion.

In this case, since the upper end height of the plurality of notch parts on the front wall is aligned, the swing part can swing around the shaft portion that extends substantially horizontally. Therefore, in a case where a large article is accommodated in the accommodation recess part, when the article comes into contact with the swing part, and the swing part is pressed, the swing part receives a load from the article and is smoothly swung and displaced rearward.

The rear panel block may include: an upper support wall on which a rear edge part of a lid member that closes the accommodation recess part is capable of being placed; and the front wall that extends downward from a front end part of the upper support wall, a lower rear portion of the front end part of the upper support wall of the accommodation recess part may be an extension space portion in which part of an outer circumference of a standard tire is arranged when the standard tire as the article is accommodated in the accommodation recess part in a horizontal arrangement state, and two of the notch parts may be formed at a position where an imaginary plane that extends vertically downward from the front end part of the upper support wall and an outer circumferential surface of the standard tire cross with each other in a state where the standard tire is accommodated in the accommodation recess part.

In this case, when the standard tire is arranged at a prescribed position in the accommodation recess part in a horizontal arrangement state, the outer circumferential surface of the standard tire causes the swing part to swing and be displaced rearward, and the outer circumferential surface of the standard tire comes into contact with edges of the two notch parts. Accordingly, when the present configuration is employed, it is possible to reliably accommodate the standard tire in the accommodation recess part, and it is possible to reduce a width in a vehicle width direction of the swing part to a minimum width.

The rear panel block may include: an upper support wall on which a rear edge part of a lid member that closes the accommodation recess part is capable of being placed; and a lower support wall, the lower support wall may be provided to protrude frontward on each of both side portions of the swing part that sandwich a lower end of the notch part of the front wall, and an inclination part having a front surface that is inclined rearward toward a middle in a vehicle width direction in plan view may be provided on a portion close to a middle in the vehicle width direction of each lower support wall.

In this case, when the standard tire is accommodated in the accommodation recess part, the lid member is placed on the upper support wall of the rear panel block. When the temporary tire is accommodated in the accommodation recess part or the like, the lid member can be placed on the lower support wall of the rear panel block. Although the lower support wall is arranged to protrude frontward on each of both side portions of the swing part that sandwich the lower end of the notch part, since the inclination part is provided on the lower support wall of each of both side portions so as to avoid interference with the outer circumferential surface of the standard tire to be accommodated, the lower support wall of both side portions is not an obstacle when the standard tire is accommodated in the accommodation recess part. Further, the lower support wall is not provided at the lower end of the swing part and therefore is not an obstacle of accommodation of the temporary tire when accommodating the temporary tire in the accommodation recess part.

The notch part may be provided over a range that does not reach the upper support wall from a lower end of the front wall.

In this case, since the notch part is formed on the front wall so as not to reach the upper support wall, it is possible to prevent the stiffness of the upper support wall from being reduced by the notch part. Therefore, the support stiffness of the upper support wall with respect to the lid member can be maintained to be high. Further, when the swing part is pressed by the standard tire and is swung, the upper support wall is not swung together, and therefore, it is possible to enhance the product property of the vehicle.

In the vehicle load room structure according to an aspect of the present invention, at least two notch parts and the swing part that is sandwiched by two notch parts and is swingable in the vehicle front-to-rear direction are provided on the front wall that faces the inside of the accommodation recess part of the rear panel block.

Therefore, the swing part moves depending on the size of the article accommodated in the accommodation recess part, and the volume of the accommodation recess part in which the article can be accommodated is changed. Accordingly, when the vehicle load room structure according to an aspect of the present invention is employed, it is possible to easily change the accommodation form of the article without requiring cumbersome detachment and attachment of a component.

### BRIEF DESCRIPTION OF THE DRAWINGS

FIG. 1 is a longitudinal cross-sectional view of a vehicle load room of an embodiment cut along a vehicle front-to-rear direction.

FIG. 2 is a perspective view of a rear panel block arranged on a rear portion of an accommodation recess part of the embodiment.

FIG. 3 is an enlarged cross-sectional view showing part of FIG. 1.

FIG. 4 is a schematic plan view of a load room rear part of the embodiment.

### DESCRIPTION OF EMBODIMENTS

Hereinafter, an embodiment of the present invention will be described with reference to the drawings. An arrow FR indicating a frontward direction of a vehicle, an arrow UP indicating an upward direction of the vehicle, and an arrow LH indicating a leftward direction of the vehicle are shown at a suitable position in the drawing.

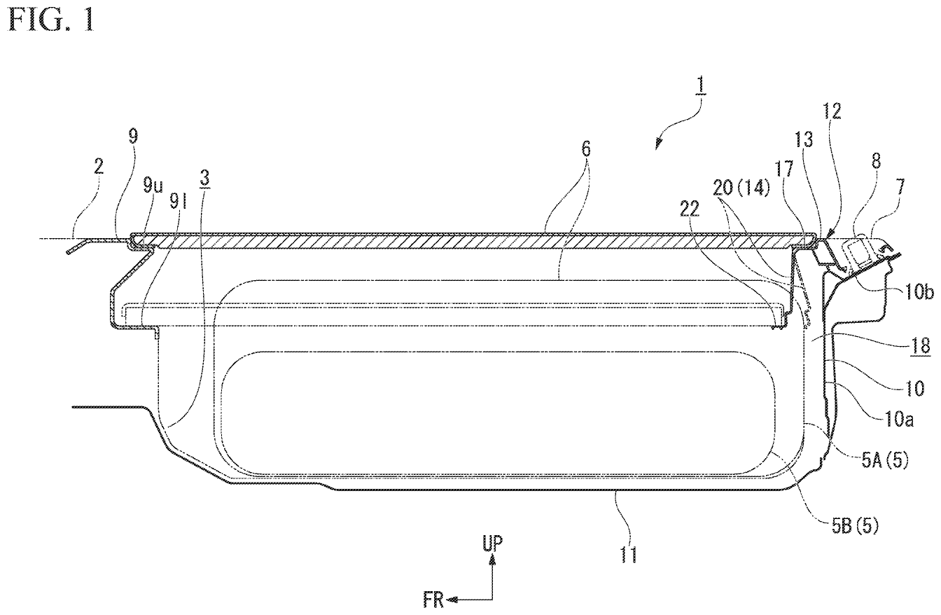

FIG. 1 is a view showing a cross-section of a load room 1 at a rear of an occupant room when cut along a vehicle front-to-rear direction.

In the load room 1, an accommodation recess part 3 that is recessed downward in a recess shape is formed on a floor surface 2 on which an article can be placed. The accommodation recess part 3 is formed such that in a top view, an opening at an upper end has a substantially rectangular shape. In the case of the present embodiment, the accommodation recess part 3 is capable of accommodating a spare tire 5. As the spare tire 5 to be accommodated, both a standard tire 5A having the same size as a travel tire and a temporary tire 5B having a smaller outer diameter and a narrower width than the standard tire 5A are assumed. An upper portion of the accommodation recess part 3 is closed by a detachable lid member 6 having a plate shape.

In FIG. 1, reference numeral 7 represents a tailgate opening at which a tailgate (not shown) is opened and closed, and reference numeral 8 represents a tailgate lock striker attached to a lower side of the tailgate opening 7.

The accommodation recess part 3 includes: a circumferential edge panel 9 that surrounds a circumferential area (a front side, a right side, and a left side) on an upper side excluding a rear side; a rear end panel 10 that forms a rear wall of the accommodation recess part 3; and a tire pan 11 that forms a bottom portion of the accommodation recess part 3. The rear end panel 10 includes: a vertical wall 10a that faces the inside of the accommodation recess part 3; and a gate flange 10b that is bent and extends diagonally rearward and upward from an upper end part of the vertical wall 10a. A rear panel block 12 made of a resin (for example, polypropylene) is attached to the gate flange 10b of the rear end panel 10. The rear panel block 12 constitutes a rear upper portion of the accommodation recess part 3.

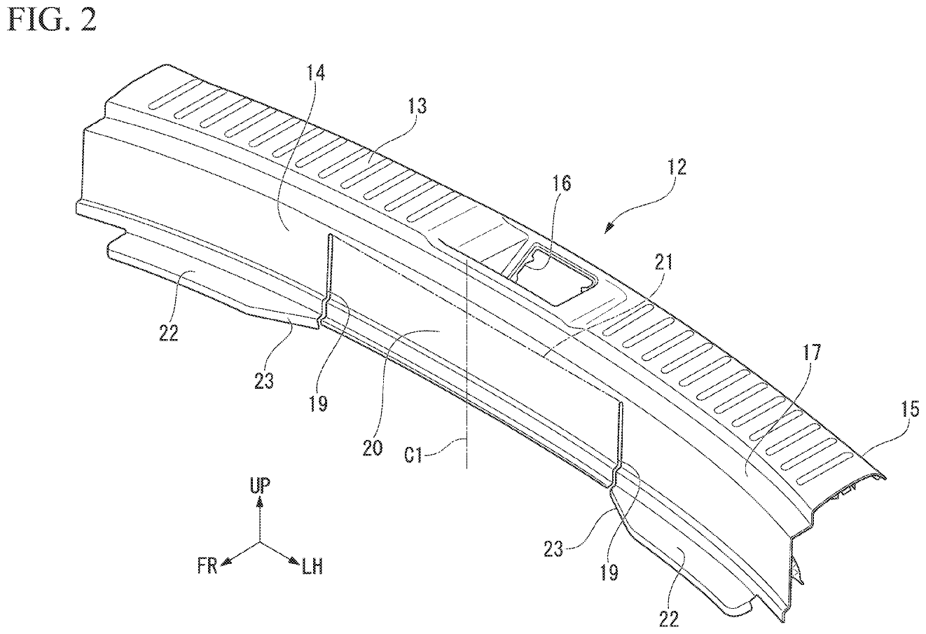

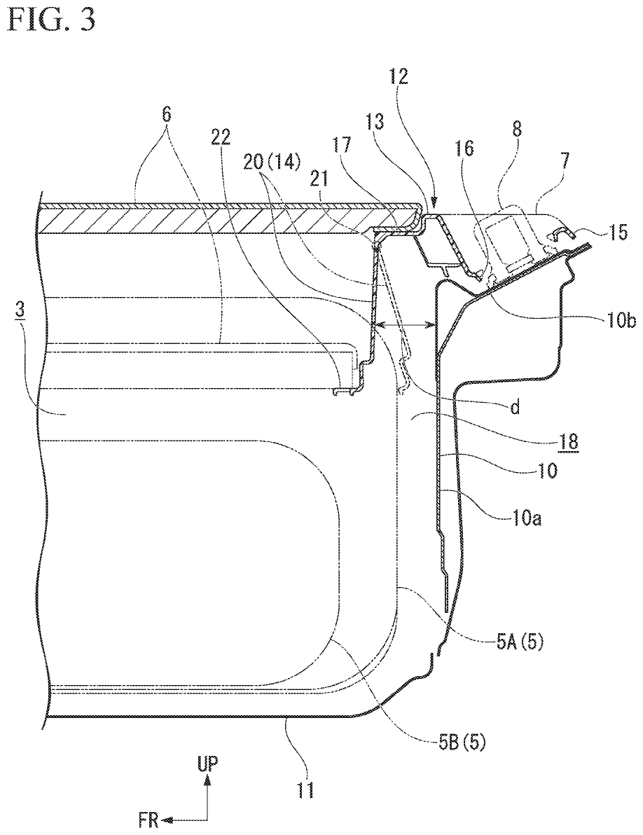

FIG. 2 is a perspective view of the rear panel block 12 seen from a front side (a side that faces the accommodation recess part 3) of the vehicle. FIG. 3 is an enlarged cross-sectional view showing a portion (a rear region of the accommodation recess part 3) of FIG. 1.

The rear panel block 12 includes: a substantially horizontal upper wall 13; a front wall 14 that extends vertically downward from a front end part of the upper wall 13; and a rear wall 15 that extends diagonally rearward downward from a rear end part of the upper wall 13. The upper wall 13, the front wall 14, and the rear wall 15 constitute a cross-section having a substantially U shape. The cross-section having a substantially U shape of the rear panel block 12 extends along a vehicle width direction and constitutes a structure body having a beam shape that extends in the vehicle width direction with a gate flange 10b. Reference numeral 16 in FIG. 2 represents an opening through which the lock striker 8 attached to the gate flange 10b is exposed upward.

An upper support wall 17 that is lowered in a step manner relative to other parts (other parts excluding a circumference edge part of the opening 16) of the upper wall 13 is provided on a front edge part of the upper wall 13 of the rear panel block 12. The upper support wall 17 extends along the vehicle width direction, and a rear edge part of the lid member 6 is capable of being placed on an upper surface of the upper support wall 17. Step heights of the upper support wall 17 and the other parts of the upper wall 13 can be preferably substantially the same as a thickness of the rear edge part of the lid member 6.

The front wall 14 of the rear panel block 12 extends vertically downward from a front end part of the upper support wall 17. The front wall 14 is arranged at a position that is separated by a predetermined distance d toward a frontward direction from the vertical wall 10a of the rear end panel 10. A lower end of the front wall 14 extends downward to be longer by a predetermined length than a front end part of the gate flange 10b.

A lower rear portion of the front end part (upper end part of the front wall 14) of the upper support wall 17 of the accommodation recess part 3 is an extension space portion 18 in which part (part of a rear end side) of an outer circumference of the standard tire 5A is arranged when the standard tire 5A is accommodated in the accommodation recess part 3 in a horizontal arrangement state. Hereinafter, for the purpose of explanation, a front side further than the extension space portion 18 of the accommodation recess part 3 is referred to as an “ordinary accommodation space portion”. The front wall 14 partitions an upper region of the accommodation recess part 3 into the ordinary accommodation space portion and the extension space portion 18.

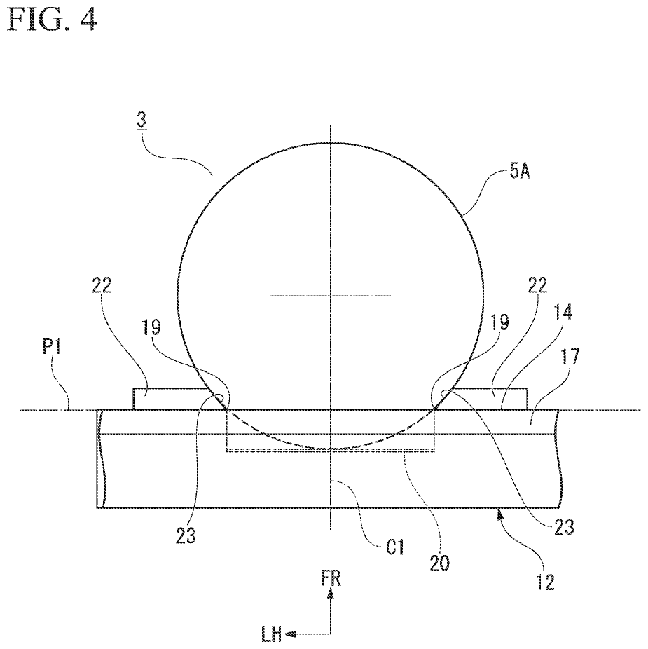

FIG. 4 is a schematic plan view of a rear part of the load room 1. As shown in FIG. 2 to FIG. 4, two notch parts 19 that extend straight in a vertical direction are provided on the front wall 14 of the rear panel block 12. The two notch parts 19 have an upper end height that is aligned to each other and have a lower end that opens downward. Each notch part 19 is formed over a range that does not reach the upper support wall 17 from a lower end of the front wall 14. The two notch parts 19 are each formed at positions that are away from a center position C1 in the vehicle width direction of the front wall 14 to right and left by an equal distance. The exact formation position of the two notch parts 19 will be described later in detail. A portion of the front wall 14 that is sandwiched between the two notch parts 19 is a swing part 20 that swings to a rear side when an external force is applied from a vehicle front side. Since the rear panel block 12 is formed of a resilient resin material such as polypropylene, the swing part 20 is deflected and deformed to the rear side when an external force is applied from the vehicle front side, and the swing part 20 returns to an original shape when the external force is released. A section that connects together upper end portions of the two notch parts 19 is a shaft portion 21, and the swing part 20 is swingable around the shaft portion 21.

A tire fixation portion (not shown) that fixes the spare tire 5 (the standard tire 5A or the temporary tire 5B) is provided at a substantially center position of a bottom portion of the accommodation recess part 3. Since the standard tire 5A has a larger outer diameter and has a wider width than the temporary tire 5B, as shown in FIG. 1 and FIG. 3, when the standard tire 5A is fixed to the tire fixation portion in a horizontal arrangement state, the standard tire 5A occupies a large space at vehicle rear and upper sides as compared to a case where the temporary tire 5B is fixed in the same manner.

The swing part 20 of the rear panel block 12 is formed such that a center position C1 in the vehicle width direction is matched with a center position of the spare tire 5 (the standard tire 5A or the temporary tire 5B) that is fixed to the tire fixation portion in the vehicle width direction.

As shown in FIG. 4, the two notch parts 19 that are provided on the front wall 14 of the rear panel block 12 are formed at a position where an imaginary plane P1 that extends vertically downward from a front end part of the upper support wall 17 and an outer circumferential surface of the standard tire 5A cross with each other in a state where the standard tire 5A is accommodated (fixed) in the accommodation recess part 3.

A lower support wall 22 that protrudes to a vehicle front side is provided on both side portions of the swing part 20 that sandwich a lower end of the notch part 19 in the front wall 14 of the rear panel block 12. As shown in FIG. 1 and FIG. 3, a rear edge part of the lid member 6 is capable of being placed on an upper surface of the lower support wall 22 of both side portions when the temporary tire 5B is accommodated in the accommodation recess part 3.

As shown in FIG. 1, an upper support portion 9u and a lower support portion 91 on which a front edge part of the lid member 6 is capable of being placed are provided on a front side portion of a circumferential edge panel 9 of the accommodation recess part 3 so as to correspond to height positions of the upper support wall 17 and the lower support wall 22 of the rear panel block 12, respectively. The upper support portion 9u and the lower support portion 91 may be provided on right and left side portions of the circumferential edge panel 9.

An inclination part 23 having a front surface that is inclined rearward toward a middle in the vehicle width direction in plan view is provided on a portion close to a middle in the vehicle width direction of each of the right and left lower support walls 22. The inclination part 23 is formed to be capable of avoiding interference of the outer circumferential surface of the standard tire 5A with the lower support wall 22 when the standard tire 5A is accommodated in the accommodation recess part 3 in a horizontal arrangement state.

The temporary tire 5B or the standard tire 5A is accommodated in the accommodation recess part 3 of the load room 1 as described below.

### <Accommodation of Temporary Tire 5B>

When the temporary tire 5B is accommodated in the accommodation recess part 3, the lid member 6 is temporarily detached, and the temporary tire 5B is arranged at a predetermined position in the accommodation recess part 3 in a horizontal arrangement state. At this time, the temporary tire 5B is fixed to the tire fixation portion on the bottom surface of the accommodation recess part 3. Since the temporary tire 5B has a smaller size than the standard tire 5A, as indicated by an imaginary line in FIG. 1 and FIG. 3, the temporary tire 5B is fitted into the ordinary accommodation space portion of the accommodation recess part 3 and does not interfere with the front wall 14 of the rear panel block 12.

In this way, after the temporary tire 5B is accommodated in the accommodation recess part 3, the front edge part of the lid member 6 is placed on the lower support portion 91 of the circumferential edge panel 9, and the rear edge part of the lid member 6 is placed on the lower support wall 22 of the rear panel block 12. In this state, the lid member 6 is arranged at a lower position than the floor surface 2 of the load room 1, and thereby, it is possible to ensure a large load room accommodation space above the lid member 6.

### <Accommodation of Standard Tire 5A>

When the standard tire 5A is accommodated in the accommodation recess part 3, the cover member 6 is temporarily detached, and the standard tire 5A is arranged at a predetermined position in the accommodation recess part 3 in a horizontal arrangement state. At this time, the standard tire 5A is fixed to the tire fixation portion on the bottom surface of the accommodation recess part 3. At this time, since the standard tire 5A has a larger outer diameter and also a wider width than the temporary tire 5B, as indicated by imaginary lines in FIG. 1 and FIG. 3, part of the outer circumferential surface of the standard tire 5A comes into contact with the front wall 14 of the rear panel block 12 and swings and displaces the front wall 14 to the vehicle rear side. In this way, a portion close to the rear of the outer circumferential surface of the standard tire 5A accommodated in the accommodation recess part 3 is arranged in the extension space portion 18 in the accommodation recess part 3.

In this way, after the standard tire 5A is accommodated in the accommodation recess part 3, the front edge part of the lid member 6 is placed on the upper support portion 9u of the circumferential edge panel 9, and the rear edge part of the lid member 6 is placed on the upper support wall 17 of the rear panel block 12. In this state, the height of the upper surface of the lid member 6 is substantially the same as that of the floor surface 2 of the load room 1, and it is possible to make the article placement surface of the load room 1 substantially flat.

As described above, in the vehicle load room structure of the present embodiment, the two notch parts 19 and the swing part 20 that is sandwiched by the two notch parts 19 and is swingable in the vehicle front-to-rear direction are provided on the front wall 14 of the rear panel block 12. Therefore, the swing part 20 moves depending on the size of the article (the spare tire 5) accommodated in the accommodation recess part 3, and the volume of the accommodation recess part 3 is changed to a volume in which the article can be accommodated. Accordingly, when the vehicle load room structure of the present embodiment is employed, it is possible to easily change the accommodation form of the article (the spare tire 5) without requiring cumbersome detachment and attachment of a complementary component.

In a case where the vehicle load room structure of the present embodiment is employed, when a small article (the spare tire 5) is accommodated in the accommodation recess part 3, since the swing part 20 closes an opening between the two notch parts 19 by the elasticity of the resin, the external appearance is not degraded.

Further, in the vehicle load room structure of the present embodiment, the two notch parts 19 that are provided on the front wall 14 of the rear panel block 12 have an upper end height that is aligned to each other and have a lower end that opens downward. Therefore, a section that connects together upper end portions of the notch parts 19 of the front wall 14 becomes the shaft portion 21, and when accommodating a large article (the spare tire 5), the swing part 20 swings and is displaced in the front-to-rear direction around the shaft portion 21. At this time, the swing part 20 swings around the shaft portion 21 that extends substantially horizontally. Accordingly, in a case where the configuration of the present embodiment is employed, when a large article (the spare tire 5) is accommodated in the accommodation recess part 3, the swing part 20 can be smoothly swung and displaced rearward.

Further, in the vehicle load room structure of the present embodiment, a lower rear portion of the front end part of the upper support wall 17 of the accommodation recess part 3 is the extension space portion 18 in which part of the outer circumference of the standard tire 5A is arranged when the standard tire 5A is accommodated in the accommodation recess part 3. The two the notch parts 19 of the front wall 14 of the rear panel block 12 are formed at a position where the imaginary plane P1 that extends vertically downward from the front end part of the upper support wall 17 and the outer circumferential surface of the standard tire 5A cross with each other. Therefore, when the standard tire 5A is arranged at a prescribed position in the accommodation recess part 3 in a horizontal arrangement state, the outer circumferential surface of the standard tire 5A causes the swing part 20 to swing rearward and comes into contact with the edges of the two notch parts 19. Accordingly, when the vehicle load room structure of the present embodiment is employed, it is possible to reliably accommodate the standard tire 5A in the accommodation recess part 3, and it is possible to reduce the width in the vehicle width direction of the swing part 20 to a minimum width.

Further, in the vehicle load room structure of the present embodiment, the lower support wall 22 of the rear panel block 12 is provided to protrude frontward on each of both side portions of the swing part 20 that sandwich the lower end of the notch part 19 of the front wall 14, and the inclination part 23 having a front surface that is inclined rearward toward the middle in the vehicle width direction in plan view is provided on a portion close to the middle in the vehicle width direction of each lower support wall 22. Therefore, when the temporary tire 5B is accommodated in the accommodation recess part 3, the lid member 6 can be placed on the lower support wall 22 of the rear panel block 12. Further, although the lower support wall 22 is arranged to protrude frontward on each of both side portions of the swing part 20 that sandwich the lower end of the notch part 19 of the front wall 14, since the inclination part 23 is provided on the lower support wall 22 of each of both side portions so as to avoid interference with the outer circumferential surface of the standard tire 5A to be accommodated, the lower support wall 22 of both side portions is not an obstacle when the standard tire 5A is accommodated in the accommodation recess part 3. Further, since the lower support wall 22 is not provided at the lower end of the swing part 20, when accommodating the temporary tire 5B in the accommodation recess part 3, it is possible to prevent the lower support wall 22 from interfering with the rear part of the temporary tire 5B and being an obstacle of accommodation of the temporary tire 5B.

Further, in the vehicle load room structure of the present embodiment, the notch part 19 that is provided on the front wall 14 of the rear panel block 12 is formed over a range that does not reach the upper support wall 17 from the lower end of the front wall 14. Therefore, high support stiffness of the upper support wall 17 with respect to the lid member 6 can be maintained without reducing the stiffness of the upper support wall 17 by the notch part 19. Further, in a case where the present configuration is employed, when the swing part 20 is pressed by the standard tire 5A and is swung, part of the upper support wall 17 is not swung together, and therefore, it is possible to enhance the product property of the vehicle.

The present invention is not limited to the embodiment described above, and various design changes can be made without departing from the scope of the invention. For example, in the embodiment described above, two notch parts 19 are provided on the front wall 14 of the rear panel block 12; however, the number of the notch parts 19 that are provided on the front wall 14 may be three or more.

Further, in the embodiment described above, the two notch parts 19 are formed along the vertical direction so as to be parallel with each other; however, a structure may be employed which includes a first notch part that extends in the vertical direction and a second notch part that extends in a horizontal direction from an upper end of the first notch part. In this case, the swing part surrounded by the two notch parts is swung and displaced in the front-to-rear direction so as to open transversely. Also in this case, it is possible to easily change the accommodation form of an article without requiring cumbersome detachment and attachment of a complementary component.

Further, in the embodiment described above, the spare tire 5 (the standard tire 5A or the temporary tire 5B) is accommodated in the accommodation recess part 3; however, an article other than the spare tire 5 may be accommodated in the accommodation recess part 3. Also in this case, if the front wall 14 of the rear panel block 12 can be swung back and forth at the swing part 20, it is possible to similarly accommodate articles having a different size.

What is claimed is:

1. A vehicle load room structure, comprising:
an accommodation recess part that is provided in a load room of a vehicle and accommodates an article,
wherein a rear upper portion of the accommodation recess part is constituted of a rear panel block, and
at least two notch parts and a swing part that is sandwiched by two of the notch parts and is swingable in a vehicle front-to-rear direction are provided on a front wall that faces an inside of the accommodation recess part of the rear panel block.

2. The vehicle load room structure according to claim 1,
wherein the plurality of notch parts that are provided on the front wall have an upper end height that is aligned to each other and have a lower end that opens downward,
a section that connects together upper end portions of the notch parts of the front wall is a shaft portion, and
the swing part is swingable around the shaft portion.

3. The vehicle load room structure according to claim 2,
wherein the rear panel block comprises:
an upper support wall on which a rear edge part of a lid member that closes the accommodation recess part is capable of being placed; and
the front wall that extends downward from a front end part of the upper support wall,
a lower rear portion of the front end part of the upper support wall of the accommodation recess part is an extension space portion in which part of an outer circumference of a standard tire is arranged when the standard tire as the article is accommodated in the accommodation recess part in a horizontal arrangement state, and
two of the notch parts are formed at a position where an imaginary plane that extends vertically downward from the front end part of the upper support wall and an outer circumferential surface of the standard tire cross with each other in a state where the standard tire is accommodated in the accommodation recess part.

4. The vehicle load room structure according to claim 1,
wherein the rear panel block includes:
an upper support wall on which a rear edge part of a lid member that closes the accommodation recess part is capable of being placed; and
a lower support wall,
the lower support wall is provided to protrude frontward on each of both side portions of the swing part that sandwich a lower end of the notch part of the front wall, and
an inclination part having a front surface that is inclined rearward toward a middle in a vehicle width direction in plan view is provided on a portion close to a middle in the vehicle width direction of each lower support wall.

5. The vehicle load room structure according to claim 2,
wherein the rear panel block includes:
an upper support wall on which a rear edge part of a lid member that closes the accommodation recess part is capable of being placed; and
a lower support wall,
the lower support wall is provided to protrude frontward on each of both side portions of the swing part that sandwich a lower end of the notch part of the front wall, and
an inclination part having a front surface that is inclined rearward toward a middle in a vehicle width direction in plan view is provided on a portion close to a middle in the vehicle width direction of each lower support wall.

6. The vehicle load room structure according to claim 3,
wherein the rear panel block includes:
an upper support wall on which a rear edge part of a lid member that closes the accommodation recess part is capable of being placed; and
a lower support wall,
the lower support wall is provided to protrude frontward on each of both side portions of the swing part that sandwich a lower end of the notch part of the front wall, and
an inclination part having a front surface that is inclined rearward toward a middle in a vehicle width direction in plan view is provided on a portion close to a middle in the vehicle width direction of each lower support wall.

7. The vehicle load room structure according to claim 4,
wherein the notch part is provided over a range that does not reach the upper support wall from a lower end of the front wall.

8. The vehicle load room structure according to claim 5,
wherein the notch part is provided over a range that does not reach the upper support wall from a lower end of the front wall.

9. The vehicle load room structure according to claim 6,
wherein the notch part is provided over a range that does not reach the upper support wall from a lower end of the front wall.
